(19) United States
(12) Patent Application Publication
(10) Pub. No.: US 2015/0049710 A1
(43) Pub. Date: Feb. 19, 2015

(54) METHOD AND TERMINAL FOR ADJUSTING HARQ BUFFER SIZE

(71) Applicant: Huawei Technologies Co., Ltd., Shenzhen (CN)

(72) Inventor: Fuqiang Zhang, Beijing (CN)

(21) Appl. No.: 14/458,479

(22) Filed: Aug. 13, 2014

(30) Foreign Application Priority Data
Aug. 15, 2013 (CN) 201310355895.6

(51) Int. Cl. H04L 1/18

(52) U.S. Cl. CPC H04L 1/1835; H04L 1/1816; H04L 1/1861
USPC 370/329

(57) ABSTRACT

The present invention provides a method and a terminal for adjusting a hybrid automatic repeat request HARQ buffer size, and relates to the field of communications technologies. A rated HARQ buffer size of a code block is reduced according to a rated proportion; then it is determined whether the reduced HARQ buffer size falls in a preset threshold range; and if the reduced HARQ buffer size falls in the preset threshold range, only partial coded data is stored. In this way, it is ensured, by setting a rated proportion, that decoding performance of the reduced coded data does not degrade greatly, and further, setting a threshold range helps to limit conditions under which the HARQ buffer size can be reduced. Consequently, technical solutions provided by embodiments of the present invention can reduce the required HARQ buffer size while ensuring decoding performance.

### CROSS-REFERENCE TO RELATED APPLICATION

This application claims priority to Chinese Patent Application No. 201310355895.6, filed on Aug. 15, 2013, which is hereby incorporated by reference in its entirety.

### TECHNICAL FIELD

The present invention relates to the field of communications technologies, and in particular, to a method and a terminal for adjusting an HARQ buffer size.

### BACKGROUND

Adaptive modulation and coding (AMC) and hybrid automatic repeat request (HARQ) technologies are used in Long Term Evolution (LTE to adapt modulation and coding according to radio link quality and perform retransmission error correction, respectively. Among HARQ technologies, incremental redundancy (IR) HARQ is employed in LTE, that is, an evolved NodeB (eNodeB) sends only an information bit and a part of redundancy bits in the first transmission process, and then sends additional redundancy bits in a subsequent retransmission process. In this way, if a terminal fails to decode data that is received for the first time, it may request the eNodeB to retransmit more redundancy bits to reduce a channel coding rate, thereby ensuring a higher decoding success rate. If the terminal still fails to perform decoding correctly with additional help of the retransmitted redundancy bits, the terminal can request the eNodeB to perform retransmission again. As the retransmission times increases, redundancy bits are continuously accumulated, and the channel coding rate is continuously reduced, so as to provide higher decoding performance.

In an IR implementation mechanism of LTE HARQ, if the terminal generates an error in decoding a currently received transport block (TB), the terminal stores demodulated soft bit data of the currently received TB, and upon receiving data retransmitted at a next time, combines the stored soft bit data with the retransmitted data, and then decodes a combination result.

At early stages of LTE development, a memory used for storing soft bits of HARQ is less than 10 MB in size. However, with introduction of various new features in LTE-Advanced, for example, code word increase and carrier aggregation (CA), a size of the memory increases several-fold. In this case, it is necessary to perform effective processing on the stored soft bits of HARQ, so as to reduce the soft bits needed to be stored and further reduce the size of the memory storing these soft bits. It is specified in section 7.1.8 of 3GPP TS36.213 for LTE that, when an HARQ buffer with a terminal class 4 is used to support CA, for a TB that can be split into a plurality of code blocks (CBs), the terminal stores only soft bits of the first half part of each CB in the TB, and discards soft bits of the latter half part; whereas for terminals of another class and terminals that do not support CA, all soft bits are required to be stored.

When a soft bit discarding solution suitable for terminal class 4 is directly applied to a terminal with a class higher than the class 4, discarding of excessive soft bits may lead to a relatively large number of HARQ retransmissions and in this case, retransmitted HARQ combination gain is reduced, thereby degrading decoding performance and further resulting in data being incorrectly transmitted. However, if protocol specifications are followed, that is, no soft bit is discarded, it is required that a terminal be configured with a large enough buffer, which increases costs of the terminal.

### SUMMARY

Embodiments of the present invention provide a method and a terminal for adjusting an HARQ buffer size, to reduce a usage cost of a terminal while ensuring decoding performance of the terminal.

To achieve the foregoing objectives, the embodiments of the present invention use the following technical solutions:

In a first aspect, an embodiment of the present invention provides a method for adjusting an HARQ buffer size, where the method includes:

receiving coded data corresponding to one code block sent by a base station;

decoding the coded data;

if decoding the coded data fails, acquiring a first rated HARQ buffer size of the code block, where the first rated HARQ buffer size is a size of space occupied by all soft bits in the coded data;

reducing the first rated HARQ buffer size according to a rated proportion to acquire a second rated HARQ buffer size;

determining a threshold range in which the second rated HARQ buffer size falls; and

when the second rated HARQ buffer size falls in a first threshold range, storing, according to the second rated HARQ buffer size, soft bits of the coded data sequentially, starting from the first soft bit in the coded data, until a size of stored soft bits is equal to the second rated HARQ buffer size.

With reference to the first aspect, in a first implementation, the rated proportion is any value ranging from 0.25 to 1.

With reference to the first aspect, in a second implementation, a lower limit value of the first threshold range is 0.5×3×K_{π}×(1−R), and an upper limit value is 3×K_{π} where R is the rated proportion, and K_{π} is

$$\frac{1}{3}$$

of a length of the code block.

With reference to the first aspect or any one of the first two implementations of the first aspect, in a third implementation, the acquiring a first rated HARQ buffer size of the code block includes:

acquiring the total number of all code blocks in a data block corresponding to the code block and a rated storage capacity of a single HARQ process of a single code word; and

dividing the rated storage capacity of the single HARQ process of the single code word by the total number of all code blocks in the data block corresponding to the code block to acquire the first rated HARQ buffer size of the code block.

With reference to the third implementation of the first aspect, in a fourth implementation, the acquiring a rated storage capacity of a single HARQ process of a single code word includes:

calculating a rated storage capacity N_{IR} of the single HARQ process of the single code word according to a formula

$${K}_{IR} = ⌊ \frac{{N}_{soft}}{{K}_{C} □ {K}_{MIMO} □ min ( {M}_{DL\_HARQ} , {M}_{limit} )} ⌋ ;$$

where N_{soft} is a maximum HARQ buffer size that can be used by the terminal;

K_{C} is a type of the terminal, and a value of K_{C} is 1 or 2 or 5;

K_{MIMO} is used to describe a transmission mode between the terminal and the base station, and a value of K_{MIMO} is 1 or 2;

min is a symbol of calculating a minimum value;

M_{DL}_{_{—}}_{HARQ} is the number of downlink HARQ processes between a base station and the terminal; and

Mₗᵢₘᵢₜ is 8.

With reference to the fourth implementation of the first aspect, in a fifth implementation, after the acquiring a rated storage capacity of a single HARQ process of a single code word, the method further includes:

determining, according to a type K_{C} of the terminal, the maximum number of carriers that can be used for data transmission between the base station and the terminal;

acquiring the actual number of carriers required for the data transmission between the base station and the terminal;

when it is determined that the actual number of carriers is smaller than the maximum number of carriers, acquiring a rated buffer size of the coded data, and storing soft bits of the coded data sequentially, starting from the first soft bit in the coded data, according to the rated buffer size of the coded data; and

when it is determined that the actual number of carriers is equal to the maximum number of carriers, performing the step of reducing the first rated HARQ buffer size according to a rated proportion to acquire a second rated HARQ buffer size and a subsequent step.

With reference to the first aspect and the first four possible implementations of the first aspect, in a sixth possible implementation, after the determining a threshold range in which the second rated HARQ buffer size falls, the method further includes:

when the second rated HARQ buffer size falls in a second threshold range, acquiring the rated buffer size of the coded data; and

according to the rated buffer size of the coded data, storing soft bits of the coded data sequentially, starting from the first soft bit in the coded data.

With reference to the sixth possible implementation of the first aspect, in a seventh possible implementation, a lower limit value of the second threshold range is 3×K_{π}, and an upper limit value is a preset value greater than 3×K_{π}, where K_{π} is

$$\frac{1}{3}$$

of a length of the code block.

In a second aspect, an embodiment of the present invention provides a terminal, where the terminal includes:

a receiving unit, configured to receive coded data corresponding to one code block sent by a base station;

a decoding unit, configured to decode the coded data received by the receiving unit;

a first acquiring unit, configured to acquire a first rated HARQ buffer size of the code block when the decoding unit fails to decode the coded data, where the first rated HARQ buffer size is a size of space occupied by all soft bits in the coded data;

a calculating unit, configured to reduce, according to a rated proportion, the first rated HARQ buffer size acquired by the first acquiring unit, to acquire a second rated HARQ buffer size;

a determining unit, configured to determine a threshold range in which the second rated HARQ buffer size acquired by the calculating unit falls; and

a storing unit, configured to: when the determining unit determines that the second rated HARQ buffer size falls in a first threshold range, store, according to the second rated HARQ buffer size, soft bits in the coded data sequentially, starting from the first soft bit in the coded data, until a size of stored soft bits is equal to the second rated HARQ buffer size.

With reference to the second aspect, in a first implementation, the rated proportion is any value ranging from 0.25 to 1.

With reference to the second aspect, in a second implementation, a lower limit value of the first threshold range is 0.5×3×K_{π}×(1−R), and an upper limit value is 3×K_{π}, where R is the rated proportion, and K_{π} is

$$\frac{1}{3}$$

of a length of the code block.

With reference to the second aspect or anyone of the first two implementations of the second aspect, in a third implementation, the first acquiring unit includes:

an acquiring module, configured to acquire the total number of all code blocks in a data block corresponding to the code block and a rated storage capacity of a single HARQ process of a single code word; and

a calculating module, configured to divide the rated storage capacity of the single HARQ process of the single code word, by the total number of all code blocks in the data block corresponding to the code block, to acquire the first rated HARQ buffer size of the code block, where the rated storage capacity of the single HARQ process of the single code word and the total number of all code blocks in the data block corresponding to the code block are acquired by the acquiring module.

With reference to the third implementation of the second aspect, in a fourth implementation, the acquiring module is configured to calculate a rated storage capacity N_{IR} of the single HARQ process of the single code word according to a formula

$${K}_{IR} = ⌊ \frac{{N}_{soft}}{{K}_{C} □ {K}_{MIMO} □ min ( {M}_{DL\_HARQ} , {M}_{limit} )} ⌋ ;$$

where N_{soft} is a maximum HARQ buffer size that can be used by the terminal;

K_{C} is a type of the terminal, and a value of K_{C} is 1 or 2 or 5;

K_{MIMO} is used to describe a transmission mode between the terminal and the base station, and a value of K_{MIMO} is 1 or 2;

min is a symbol of calculating a minimum value;

M_{DL}_{_{—}}_{HARQ} is the number of downlink HARQ processes between a base station and the terminal; and

Mₗᵢₘᵢₜ is 8.

With reference to the fourth implementation of the second aspect, in a fifth implementation, the terminal further includes:

a determining unit, configured to determine the maximum number of carriers that can be used for data transmission between the base station and the terminal;

a second acquiring unit, configured to acquire the actual number of carriers required for the data transmission between the base station and the terminal; and

a third acquiring unit, configured to acquire a rated buffer size of the coded data when the second acquiring unit determines that the actual number of carriers is smaller than the maximum number of carriers;

the storing unit is further configured to store soft bits of the coded data sequentially, starting from the first soft bit in the coded data, according to the rated buffer size of the coded data; and

the calculating unit is further configured to reduce the first rated HARQ buffer size according to a rated proportion to acquire a second rated HARQ buffer size when the second acquiring unit determines that the actual number of carriers is equal to the maximum number of carriers.

With reference to the second aspect and the first five possible implementations of the second aspect, in a sixth possible implementation, the terminal further includes:

a fourth acquiring unit, configured to acquire the rated buffer size of the coded data when the second rated HARQ buffer size acquired by the second acquiring unit falls in a second threshold range; and

the storing unit is further configured to store soft bits of the coded data sequentially, starting from the first soft bit in the coded data, according to the rated buffer size of the coded data acquired by the fourth acquiring unit.

With reference to the sixth possible implementation of the second aspect, in a seventh possible implementation, a lower limit value of the second threshold range is 3×K_{π}, and an upper limit value is a preset value greater than 3×K_{π}, where K_{π} is

$$\frac{1}{3}$$

of the length of the code block.

By using the method and the terminal for adjusting an HARQ buffer size according to embodiments of the present invention, a rated HARQ buffer size of a code block is reduced according to a rated proportion; then it is determined whether the reduced HARQ buffer size falls in a preset threshold range; and if the reduced HARQ buffer size falls in the preset threshold range, only partial coded data is stored. In this way, it is ensured, by setting a rated proportion, that decoding performance of the reduced coded data does not degrade greatly, and further, setting a threshold range helps to limit conditions under which the HARQ buffer size can be reduced. Compared with the prior art, which faces a dilemma between insufficient buffer size due to preservation of all coded data and decoding performance degradation due to storage of only common coded data, the technical solutions provided by the embodiments of the present invention can reduce the required HARQ buffer size while ensuring decoding performance, thereby reducing costs of a terminal, and achieving a balance between cost control and decoding performance.

### BRIEF DESCRIPTION OF DRAWINGS

To describe the technical solutions in the embodiments of the present invention or in the prior art more clearly, the following briefly introduces accompanying drawings required for describing the embodiments or the prior art. Apparently, the accompanying drawings in the following description show merely some embodiments of the present invention, and a person of ordinary skill in the art may still derive other drawings according to these accompanying drawings without creative efforts.

FIG. 1 is a flowchart of a method for adjusting an HARQ buffer size according to an embodiment of the present invention;

FIG. 2 is a schematic diagram of a size of relevant data in a code block in the prior art;

FIG. 3 is a flowchart of another method for adjusting an HARQ buffer size according to an embodiment of the present invention;

FIG. 4 is a flowchart of another method for adjusting an HARQ buffer size according to an embodiment of the present invention;

FIG. 5 is a schematic diagram of a size of relevant data in a code block according to an embodiment of the present invention;

FIG. 6 is a structural diagram of a terminal according to an embodiment of the present invention;

FIG. 7 is a structural diagram of another terminal according to an embodiment of the present invention;

FIG. 8 is a structural diagram of another terminal according to an embodiment of the present invention;

FIG. 9 is a structural diagram of another terminal according to an embodiment of the present invention; and

FIG. 10 is a structural diagram of another terminal according to an embodiment of the present invention.

### DESCRIPTION OF EMBODIMENTS

The following clearly describes the technical solutions in the embodiments of the present invention with reference to the accompanying drawings in the embodiments of the present invention. Apparently, the embodiments to be described are merely a part rather than all of the embodiments of the present invention. All other embodiments obtained by a person of ordinary skill in the art based on the embodiments of the present invention without creative efforts shall fall within the protection scope of the present invention.

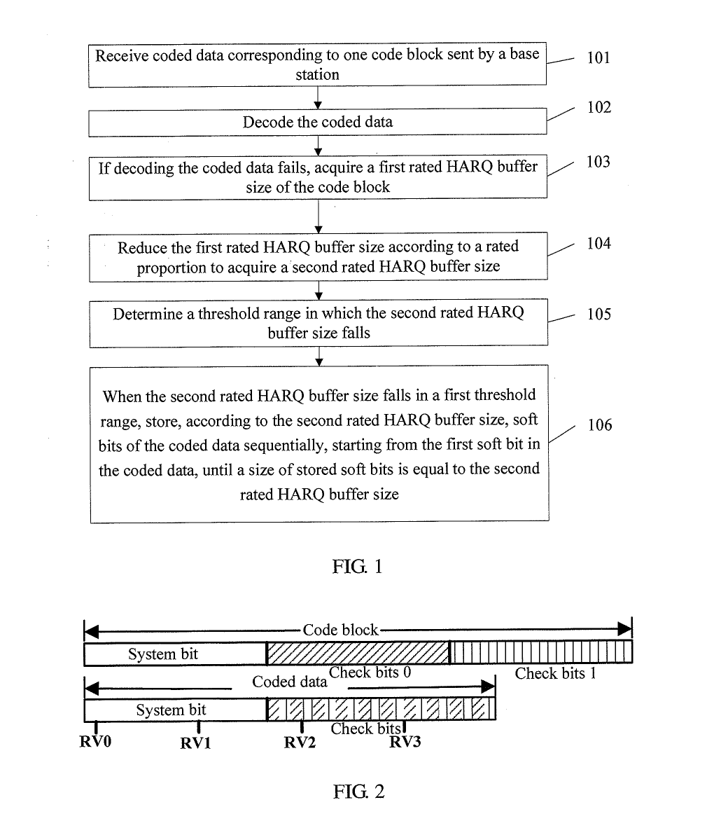

FIG. 1 describes a method for adjusting an HARQ buffer size according to an embodiment of the present invention. This method is executed by a terminal and can be applied to a turbo coding-based data transmission process between a base station and a terminal in an LTE system architecture. This embodiment includes:

101. Receive coded data corresponding to one code block sent by a base station.

CB is a Turbo-encoded code block, and a bit sequence in one CB corresponds to one coding unit of a Turbo code. A plurality of CBs may form one TB. When a TB is relatively small, there may be only one CB; and when the TB is relatively large, the TB may be segmented into a plurality of CBs, and a CRC check bit is appended to each TB, to facilitate data correctness verification after Turbo code decoding. It is specified in LTE related standards that, the number of CBs may change from 1 to 20 according to a size of a TB.

Coded data is formed by partial or all data in a CB. Data in one CB includes a system bit, check bits 0 and check bits 1. The system bit is source data, check bits 0 are a first part of redundancy bits generated by a Turbo coder according to the source data, and check bits 1 are a second part of redundancy bits generated by the Turbo coder according to the source data. The coded data sent by a base station to a terminal is generated based on a system bit, check bits 0 and check bits 1. A specific method is: placing the system bit in the front, and then placing the check bits 0 and the check bits 1 alternately, that is, placing one check bit 0 and then placing one check bit 1, then placing one check bit 0, . . . until a total data length is equal to a rated buffer size of the coded data.

Moreover, it is specified in relevant LTE standards that four transport start points RV0, RV1, RV2, and RV3 are generally set in coded data of one CB, as shown in FIG. 2.

When coded data is transported for the first time, a base station may send the coded data starting from the RV0. In a subsequent retransmission process, the base station may select any one of the RV0, the RV1, the RV2 and the RV3 start points to send the coded data.

102. Decode the coded data.

The terminal decodes the coded data, that is, performs turbo decoding on the coded data.

103. If decoding the coded data fails, acquire a first rated HARQ buffer size of the code block.

The first rated HARQ buffer size is a size of space occupied by all soft bits in the coded data corresponding to the code block.

104. Reduce the first rated HARQ buffer size according to a rated proportion to acquire a second rated HARQ buffer size.

105. Determine a threshold range in which the second rated HARQ buffer size falls.

106. When the second rated HARQ buffer size falls in a first threshold range, store, according to the second rated HARQ buffer size, soft bits of the coded data sequentially, starting from the first soft bit in the coded data, until a size of stored soft bits is equal to the second rated HARQ buffer size.

According to the method for adjusting an HARQ buffer size, a rated HARQ buffer size of a code block is reduced according to a rated proportion; then it is determined whether the reduced HARQ buffer size falls in a preset threshold range; and if the reduced HARQ buffer size falls in the preset threshold range, only partial coded data is stored. In this way, it is ensured, by setting a rated proportion, that decoding performance of the reduced coded data does not degrade greatly, and further, setting a threshold range helps to limit conditions under which the HARQ buffer size can be reduced. Compared with the prior art, which faces a dilemma between insufficient buffer size due to preservation of all coded data and decoding performance degradation due to storage of only common coded data, the technical solution provided by this embodiment of the present invention can reduce the required HARQ buffer size while ensuring decoding performance, thereby reducing costs of a terminal, and achieving a balance between cost control and decoding performance.

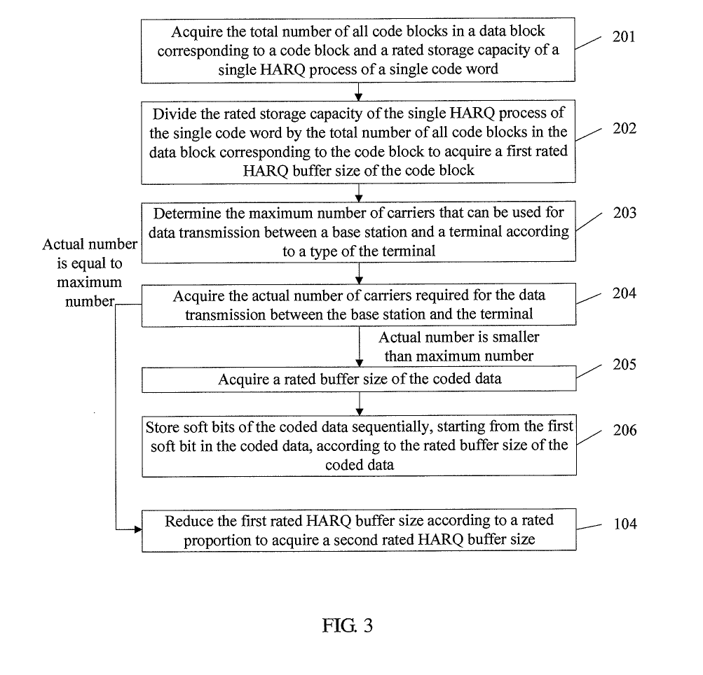

Further, based on any one implementation method shown in FIG. 2 and FIG. 3, in this embodiment of the present invention, the rated proportion needs to be set to range from 0.25 to 1.

A part of system bits before RV0 is not transmitted during initial transmission, and check bits corresponding to this part of system bits are very important; if the check bits corresponding to this part of system bits are discarded, performance of a next retransmission will be greatly affected. The rated proportion in this embodiment of the present invention is set to range from 0.25 to 1. Compared with the prior method in which half of soft bits are discarded, this embodiment of the present invention can ensure that check bits corresponding to a part of system bits which are not transmitted before the RV0 in an initial transmission process can be preserved in most scenarios. Consequently, it can be ensured that performance of subsequent retransmission is not greatly degraded.

Further, based on an implementation method of the steps 101 to 106, in this embodiment of the present invention, a lower limit value of the first threshold range may be set to 0.5×3×K_{π}×(1−R), and an upper limit value may be set to 3×K_{π},

where, R is the rated proportion, and K_{π} is

$$\frac{1}{3}$$

of a length of the code block.

In this embodiment of the present invention, after the means for setting the first threshold range is used, because LTE related standards specify that a rated buffer size of coded data is

$${N}_{cb} = min ( \frac{{N}_{IR}}{C} , 3 \times {K}_{Π} ) ,$$

where

$$\frac{{N}_{IR}}{C}$$

is a first rated HARQ buffer size, and N_{sb}=N_{cb}, the present invention needs to ensure that an HARQ buffer size of a terminal after some check bits are discarded is only (1−R) times a value specified in the foregoing LTE relevant standards, that is, is equal to

$$\frac{{N}_{IR}}{C} \times ( 1 - R )$$

or 3×K_{π}. When a TB is small, the number of CBs is small, that is, a smaller value of C makes a larger value of

$$\frac{{N}_{IR}}{C} .$$

When the TB is so small that

$$\frac{{N}_{IR}}{C} \times ( 1 - R )$$

is greater than 3×K_{π}, that is, a buffer space specified in the foregoing LTE relevant standards is still greater than 3×K_{π} after being reduced by R, implementing N_{sb}=N_{cb}=3×K_{π} directly can also ensure that a buffer occupied by a single HARQ process of a single code word finally does not exceed N_{IR}. However, when a TB is large, C is large too, which makes a value of

$$\frac{{N}_{IR}}{C}$$

smaller. In this case,

$$\frac{{N}_{IR}}{C} \times ( 1 - R )$$

is smaller than or equal to 3×K_{π}. It is required that a soft bit length N_{sb}, actually stored by the terminal, of each CB cannot be equal to N_{cb}; otherwise, the HARQ buffer of the terminal is more than 1−R times the value specified in the foregoing LTE relevant standards. To ensure that the HARQ buffer of the terminal is within a range of the specified value, N_{sb} should be equal to

$${N}_{sb} = ⌊ ( 1 - R ) \times \frac{{N}_{IR}}{C} ⌋ .$$

It can be seen that, by using the foregoing means for setting the first threshold range, it is ensured that a second HARQ buffer size generated after reduction falls in the range

$${N}_{cb} = min ( \frac{{N}_{IR}}{C} , 3 \times {K}_{Π} )$$

specified in the foregoing LTE relevant standards.

Further, based on an implementation method in steps 101 to 106, in this embodiment of the present invention, the following steps are performed when step 103 is implemented. As shown in FIG. 3, the steps include:

201. Acquire the total number of all code blocks in a data block corresponding to the code block and a rated storage capacity of a single HARQ process of a single code word.

A method for calculating the rated storage capacity of the single HARQ process of the single code word according to this embodiment of the present invention is as follows:

calculating a rated storage capacity N_{IR} of a single HARQ process of a single code word according to a formula

$${N}_{IR} = ⌊ \frac{{N}_{soft}}{{K}_{C} □ {K}_{MIMO} □ min ( {M}_{DL\_HARQ} , {M}_{limit} )} ⌋ ,$$

where N_{soft} is a maximum HARQ buffer size that can be used by the terminal; K_{C} is a type of the terminal, and a value of K_{C} is 1 or 2 or 5; K_{MIMO} is used to describe a transmission mode between the terminal and the base station, and a value of K_{MIMO} is 1 or 2; min is a symbol of calculating a minimum value; M_{DL}_{_{—}}_{HARQ} is the number of downlink HARQ processes between a base station and the terminal; and Mₗᵢₘᵢₜ is 8.

When K_{C} is equal to 2 or K_{C} is equal to 5, it indicates that the terminal supports CA; and when K_{C} is equal to 1, it indicates that the terminal does not support the CA. When K_{MIMO} is equal to 2, it indicates that the terminal supports a dual-code word spatial multiplexing transmission mode; and when K_{MIMO} is equal to 1, it indicates that the terminal supports a transmission mode other than dual-code word spatial multiplexing.

202. Divide the rated storage capacity of the single HARQ process of the single code word by the total number of all code blocks in the data block corresponding to the code block to acquire the first rated HARQ buffer size of the code block.

Further, after steps 201 and 202 are performed, this embodiment of the present invention further provides a method process, shown in FIG. 3, for adjusting the first rated HARQ buffer size, where the method includes:

203. Determine, according to a type K_{C} of the terminal, the maximum number of carriers that can be used for data transmission between the base station and the terminal.

204. Acquire the actual number of carriers required for the data transmission between the base station and the terminal. When it is determined that the actual number of carriers is smaller than the maximum number of carriers, step 205 is performed; otherwise, step 104 and a subsequent step thereof are performed.

205. Acquire a rated buffer size of the coded data.

206. Store soft bits of the coded data sequentially, starting from the first soft bit in the coded data, according to the rated buffer size of the coded data.

In this embodiment of the present invention, after steps 203 to 206 are adopted, because a corresponding buffer space needs to be set separately for transmission data borne by different carriers, when it is determined that the actual number of carriers is smaller than the maximum number of carriers, each actual carrier can occupy a buffer space that is preset but is not actually used, thereby ensuring that the coded data borne by each carrier can have an enough buffer space, and ensuring decoding performance.

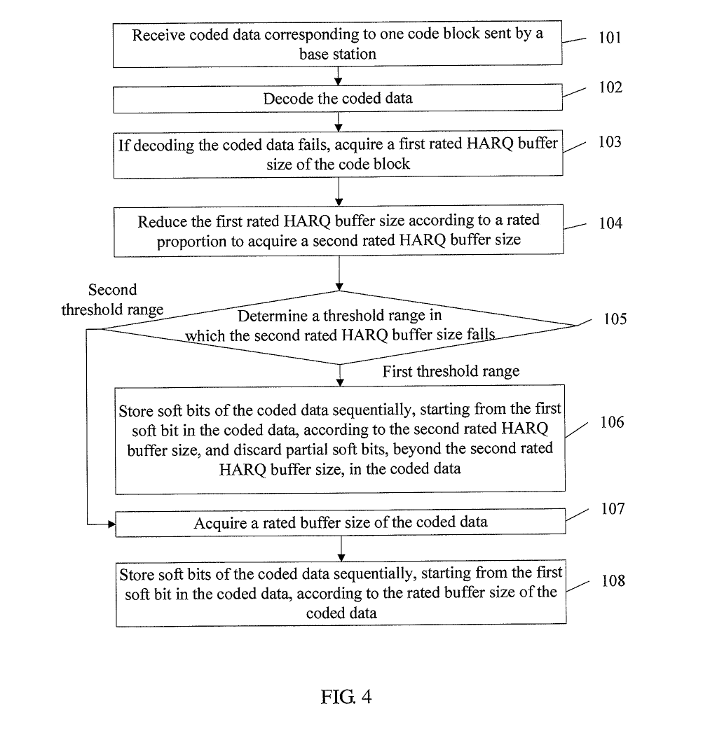

Alternatively, after the step 105 of determining a threshold range in which the second rated HARQ buffer size falls is performed, as shown in FIG. 4, this embodiment of the present invention further includes the following steps.

107. When the second rated HARQ buffer size falls in a second threshold range, acquire a rated buffer size of the coded data.

108. Store soft bits of the coded data sequentially, starting from the first soft bit in the coded data, according to the rated buffer size of the coded data.

In this embodiment of the present invention, by employing steps 107 and 108, a second threshold range is set so that the terminal can store all coded data, thereby ensuring the decoding performance.

Further, a lower limit value of the second threshold range may be set to 3×K_{π}, and an upper limit value is a preset value greater than 3×K_{π}, where K_{π} is

$$\frac{1}{3}$$

of the length of the code block.

In this embodiment of the present invention, after the foregoing means for setting the second threshold range is adopted, the second threshold range is adjacent to the foregoing first threshold range, so as to ensure that all values can be included. Consequently, general applicability of the method provided by this embodiment of the present invention is ensured.

Herein, this embodiment of the present invention specifically describes a method for adjusting an HARQ buffer size according to the present invention, based on an example in which in an LTE scenario, a terminal class is 6, CA is supported, a dual-code word spatial multiplexing transmission mode is used, and a rated proportion is

$$\frac{1}{4} .$$

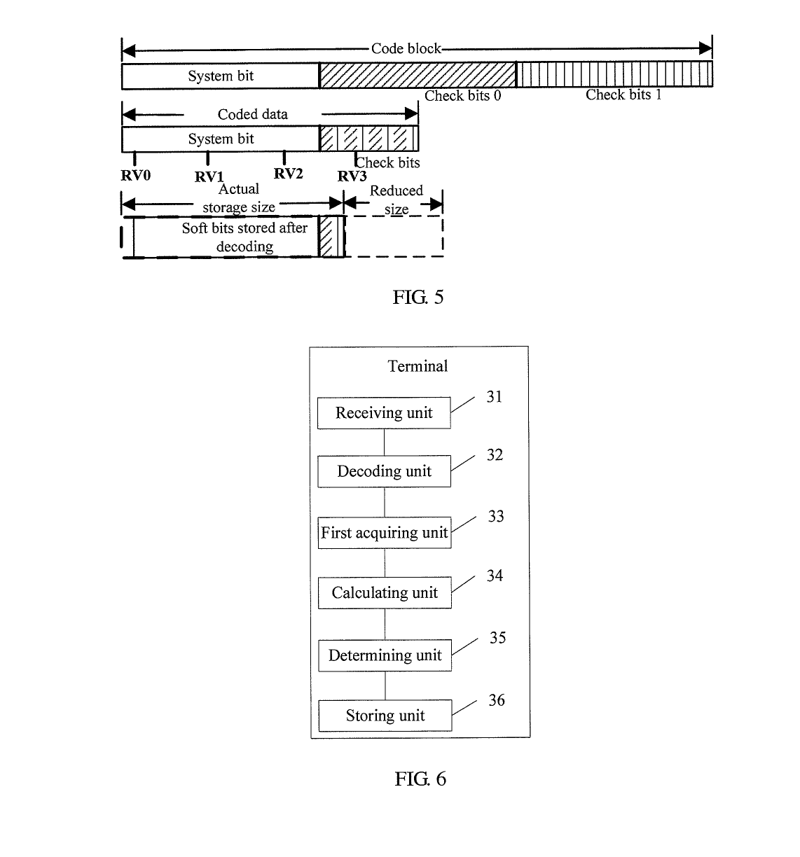

FIG. 5 is a schematic diagram of parameter length comparison in the method process.

Assuming that a size of one data block TB is 75376 bits, after turbo coding is performed for the data block, a size of a generated single code block CB is 3×K_{π}=3×5856=17568 bits. In this case, a first rated HARQ buffer size of the code block is

$$\frac{{N}_{IR}}{C} = 8784 = 0.5 \times 3 \times {K}_{Π}$$

and is reduced according to a rated proportion R, which is equal to

$$\frac{1}{4}$$

in this example, acquire a second rated HARQ buffer size

$$( 1 - R ) \frac{{N}_{IR}}{C} = 0.75 \times 8784 = 0.75 \times 0.5 \times 3 \times {K}_{Π}$$

that is,

$$( 1 - R ) \frac{{N}_{IR}}{C} ∈ [ 0.75 \times 0.5 \times 3 \times {K}_{Π} , 3 \times {K}_{Π} ] .$$

### Then,

$$( 1 - R ) \frac{{N}_{IR}}{C}$$

is used as an actual storage size for storing the first

$$\frac{3}{4}$$

part of the coded data corresponding to the code block.

An embodiment of the present invention further provides a terminal to implement method processes shown in FIG. 1 to FIG. 5. FIG. 6 is a structural block diagram of the terminal, where the terminal includes: a receiving unit 31, a decoding unit 32, a first acquiring unit 33, a calculating unit 34, a determining unit 35, and a storing unit 36.

The receiving unit 31 is configured to receive coded data corresponding to one code block sent by a base station.

The decoding unit 32 is configured to decode the coded data received by the receiving unit 31.

The first acquiring unit 33 is configured to acquire a first rated HARQ buffer size of the code block when the decoding unit 32 fails to decode the coded data,

where the first rated HARQ buffer size is a size of space occupied by all soft bits in the coded data.

The calculating unit 34 is configured to reduce the first rated HARQ buffer size acquired by the first acquiring unit 33, according to a rated proportion, to acquire a second rated HARQ buffer size.

The determining unit 35 is configured to determine a threshold range in which the second rated HARQ buffer size acquired by the calculating unit 34 falls.

The storing unit 36 is configured to: when the determining unit 35 determines that the second rated HARQ buffer size falls in a first threshold range, store, according to the second rated HARQ buffer size, soft bits in the coded data sequentially, starting from the first soft bit in the coded data, until a size of stored soft bits is equal to the second rated HARQ buffer size,

where, the rated proportion is any value ranging from 0.25 to 1; and

a lower limit value of the first threshold range is 0.5×3×K_{π}×(1−R), and an upper limit value is 3×K_{π}, where R is the rated proportion, and K_{π} is

$$\frac{1}{3}$$

of a length of the code block.

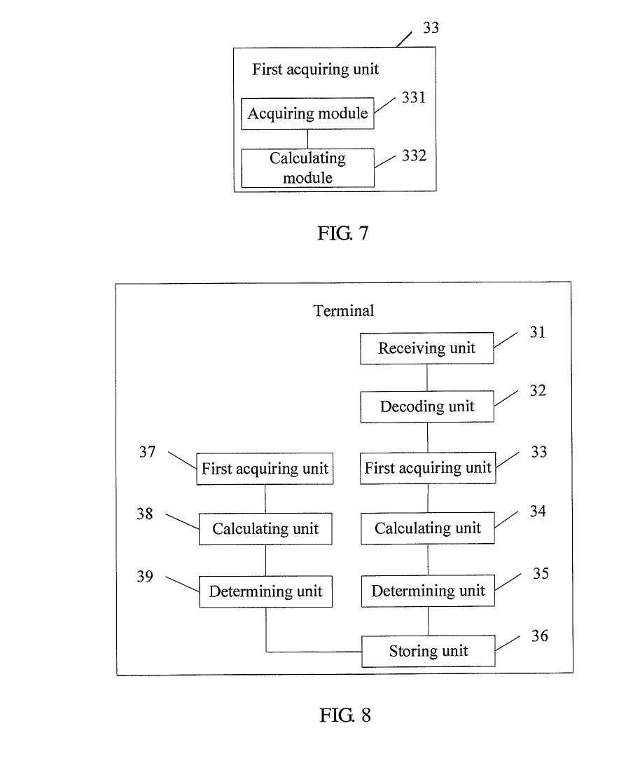

Optionally, as shown in FIG. 7, the first acquiring unit 33 includes:

an acquiring module 331, configured to acquire the total number of all code blocks in a data block corresponding to the code block and a rated storage capacity of a single HARQ process of a single code word; and

a calculating module 332, configured to divide the rated storage capacity of the single HARQ process of the single code word, by the total number of all code blocks in the data block corresponding to the code block, to acquire a first rated HARQ buffer size of the code block, where the rated storage capacity of the single HARQ process of the single code word and the total number of all code blocks in the data block corresponding to the code block are acquired by the acquiring module.

Optionally, the acquiring module is configured to calculate a rated storage capacity N_{IR} of a single HARQ process of a single code word according to a formula

$${N}_{IR} = ⌊ \frac{{N}_{soft}}{{K}_{C} □ {K}_{MIMO} □ min ( {M}_{DL\_HARQ} , {M}_{limit} )} ⌋ ;$$

where, N_{soft} is a maximum HARQ buffer size that can be used by the terminal;

K_{C} is a type of the terminal, and a value of K_{C} is 1 or 2 or 5;

K_{MIMO} is used to describe a transmission mode between the terminal and the base station, and a value of K_{MIMO} is 1 or 2;

min is a symbol of calculating a minimum value;

M_{DL}_{_{—}}_{HARQ} is the number of downlink HARQ processes between a base station and the terminal; and

Mₗᵢₘᵢₜ is 8.

Optionally, as shown in FIG. 8, the terminal further includes:

a determining unit 37, configured to determine, according to the type of the terminal, the maximum number of carriers that can be used for data transmission between the base station and the terminal;

a second acquiring unit 38, configured to acquire the actual number of carriers required for the data transmission between the base station and the terminal; and

a third acquiring unit 39, configured to acquire a rated buffer size of the coded data when the second acquiring unit 38 determines that the actual number of carriers is smaller than the maximum number of carriers.

The storing unit 36 is further configured to store soft bits of the coded data sequentially, starting from the first soft bit in the coded data, according to the rated buffer size of the coded data.

Optionally, the calculating unit 34 is further configured to: when the second acquiring unit 38 determines that the actual number of carriers is equal to the maximum number of carriers, reduce the first rated HARQ buffer size according to a rated proportion to acquire a second rated HARQ buffer size.

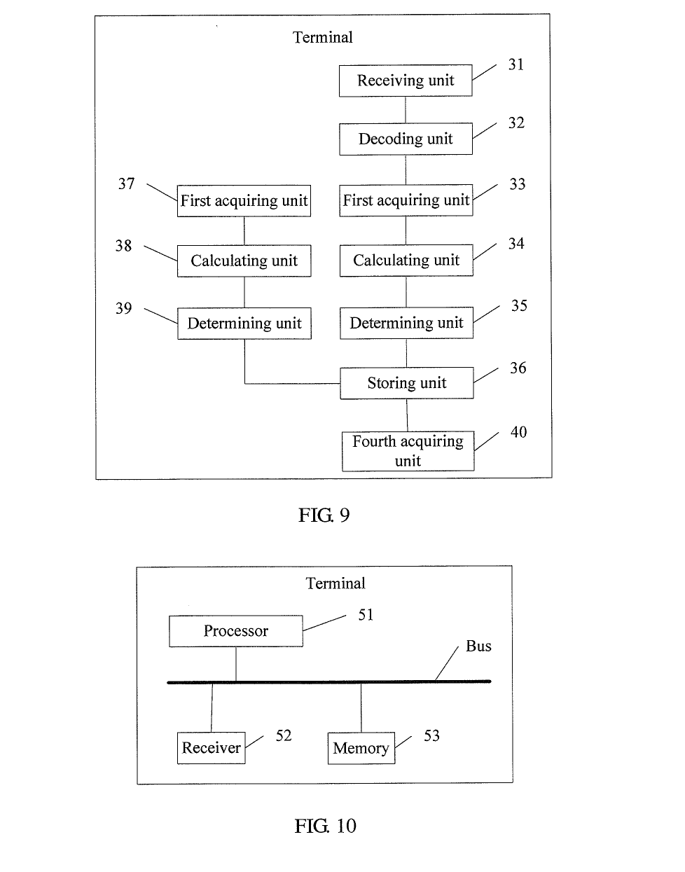

Optionally, as shown in FIG. 9, the terminal further includes:

a fourth acquiring unit 40, configured to acquire the rated buffer size of the coded data when the second rated HARQ buffer size acquired by the second acquiring unit falls in a second threshold range.

The storing unit 36 is further configured to store soft bits of the coded data sequentially, starting from the first soft bit in the coded data, according to the rated buffer size of the coded data acquired by the fourth acquiring unit 40.

A lower limit value of the second threshold range is 3×K_{π}, and an upper limit value is a preset value greater than 3×K_{π}, where K_{π} is

$$\frac{1}{3}$$

of the length of the code block.

By using the terminal for adjusting an HARQ buffer size according to this embodiment of the present invention, a rated HARQ buffer size of a code block is reduced according to a rated proportion; then it is determined whether the reduced HARQ buffer size falls in a preset threshold range; and if the reduced HARQ buffer size falls in the preset threshold range, only partial coded data is stored. In this way, it is ensured, by setting a rated proportion, that decoding performance of the reduced coded data does not degrade greatly, and further, setting a threshold range helps to limit conditions under which the HARQ buffer size can be reduced. Compared with the prior art, which faces a dilemma between insufficient buffer size due to preservation of all coded data and decoding performance degradation due to storage of only common coded data, the technical solution provided by this embodiment of the present invention can reduce the required HARQ buffer size while ensuring decoding performance.

For specific functions completed by each unit or part in the terminal provided by this embodiment of the present invention, reference may be made to the foregoing method embodiment.

An embodiment of the present invention further provides a terminal. As shown in FIG. 10, the terminal includes a processor 51, a receiver 52, and a memory 53, where the memory 53 is configured with code, the processor 51 is configured to call the code configured in the memory 53 to implement the method processes shown in FIG. 1 to FIG. 5, and moreover, communication between the processor 51, the receiver 52 and the memory 53 is implemented using a bus.

The receiver 52 is configured to receive coded data corresponding to one code block sent by a base station.

The processor 51 is configured to decode the coded data; if decoding the coded data fails, acquire a first rated HARQ buffer size; reduce the first rated HARQ buffer size according to a rated proportion to acquire a second rated HARQ buffer size; determine a threshold range in which the second rated HARQ buffer size falls; and when the second rated HARQ buffer size falls in the first threshold range, store, according to the second rated HARQ buffer size, soft bits of the coded data sequentially, starting from the first soft bit in the coded data, until a size of stored soft bits is equal to the second rated HARQ buffer size.

The memory 53 is configured to store coded data corresponding to one code block, and the first rated HARQ buffer size of the code block, the rated proportion, the second rated HARQ buffer size, and a first threshold range.

The first rated HARQ buffer size is a size of space occupied by all soft bits in the coded data.

The rated proportion is any value ranging from 0.25 to 1.

A lower limit value of the first threshold range is 0.5×3×K_{π}×(1−R), and an upper limit value is 3×K_{π}, where R is the rated proportion, and K_{π} is

$$\frac{1}{3}$$

of a length of the code block.

Optionally, the processor 51 is further configured to acquire the total number of all code blocks in the data block corresponding to the code block and a rated storage capacity of a single HARQ process of a single code word; and divide the rated storage capacity of the single HARQ process of the single code word by the total number of all code blocks in the data block corresponding to the code block, to acquire the first rated HARQ buffer size of the code block.

The memory 53 is further configured to store the total number of all code blocks in the data block corresponding to the code block and the rated storage capacity of the single HARQ process of the single code word.

Optionally, the processor 51 is configured to calculate a rated storage capacity N_{IR} of a single HARQ process of a single code word according to a formula

$${N}_{IR} = ⌊ \frac{{N}_{soft}}{{K}_{C} □ {K}_{MIMO} □ min ( {M}_{DL\_HARQ} , {M}_{limit} )} ⌋ ;$$

where, N_{soft} is a maximum HARQ buffer size that can be used by the terminal;

K_{C} is a type of the terminal, and a value of K_{C} is 1 or 2 or 5;

K_{MIMO} is used to describe a transmission mode between the terminal and the base station, and a value of K_{MIMO} is 1 or 2;

min is a symbol of calculating a minimum value;

M_{DL}_{_{—}}_{HARQ} is the number of downlink HARQ processes between a base station and the terminal; and

Mₗᵢₘᵢₜ is 8.

Optionally, the processor 51 is further configured to determine, according to the type K_{C} of the terminal, the maximum number of carriers that can be used for data transmission between the base station and the terminal; acquire the actual number of carriers required for the data transmission between the base station and the terminal; when it is determined that the actual number of carriers is smaller than the maximum number of carriers, acquire a rated buffer size of the coded data; and store soft bits of the coded data sequentially, starting from the first soft bit in the coded data, according to the rated buffer size of the coded data; and, when it is determined that the actual number of carriers is equal to the maximum number of carriers, perform the step of reducing the first rated HARQ buffer size according to the rated proportion to acquire the second rated HARQ buffer size and a subsequent step.

The memory 53 is further configured to store the maximum number of carriers that can be used for data transmission between the base station and the terminal, the actual number of carriers required for the data transmission between the base station and the terminal, and the rated buffer size of the coded data.

Optionally, the processor 51 is further configured to acquire the rated buffer size of the coded data when the second rated HARQ buffer size falls in a second threshold range; and store soft bits of the coded data sequentially, starting from the first soft bit in the coded data, according to the rated buffer size of the coded data;

where, a lower limit value of the second threshold range is 3×K_{π}, and an upper limit value is a preset value greater than 3×K_{π}, where K_{π} is

$$\frac{1}{3}$$

of the length of the code block.

By using the terminal for adjusting an HARQ buffer size according to this embodiment of the present invention, a rated HARQ buffer size of a code block is reduced according to a rated proportion; then it is determined whether the reduced HARQ buffer size falls in a preset threshold range; and if the reduced HARQ buffer size falls in the preset threshold range, only partial coded data is stored. In this way, it is ensured, by setting a rated proportion, that decoding performance of the reduced coded data does not degrade greatly, and further, setting a threshold range helps to limit conditions under which the HARQ buffer size can be reduced. Compared with the prior art, which faces a dilemma between insufficient buffer size due to preservation of all coded data and decoding performance degradation due to storage of only common coded data, the technical solution provided by this embodiment of the present invention can reduce the required HARQ buffer size while ensuring decoding performance, thereby reducing costs of the terminal.

For specific functions completed by each unit or part in the terminal provided by this embodiment of the present invention, reference may be made to the foregoing method embodiment.

From the foregoing descriptions of the embodiments, a person skilled in the art may clearly understand that the present invention may be implemented by software in addition to necessary universal hardware, and may also be implemented by hardware. However, the former is preferred implementation. Based on such an understanding, the technical solutions of the present invention essentially, or the part contributing to the prior art may be implemented in a form of a software product. The computer software product is stored in a readable storage medium, such as a floppy disk, a hard disk or an optical disc of a computer, and includes several instructions for instructing a computer device (which may be a personal computer, a server, a network device, or the like) to perform the methods described in the embodiments of the present invention.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for adjusting a hybrid automatic repeat request HARQ buffer size, comprising:
receiving coded data corresponding to one code block sent by a base station;
decoding the coded data;
if decoding the coded data fails, acquiring a first rated HARQ buffer size of the code block, wherein the first rated HARQ buffer size is a size of space occupied by all soft bits in the coded data corresponding to the code block;
reducing the first rated HARQ buffer size according to a rated proportion to acquire a second rated HARQ buffer size;
determining a threshold range in which the second rated HARQ buffer size falls; and
when the second rated HARQ buffer size falls in a first threshold range, storing soft bits of the coded data sequentially, starting from the first soft bit in the coded data, until a size of stored soft bits is equal to the second rated HARQ buffer size.

2. The method according to claim 1, wherein the rated proportion is any value ranging from 0.25 to 1.

3. The method according to claim 1, wherein a lower limit value of the first threshold range is 0.5×3×K_{π}×(1−R), and an upper limit value is 3×K_{π}, wherein R is the rated proportion, and K_{π} is
$$\frac{1}{3}$$
of a length of the code block.

4. The method according to claim 1, wherein the acquiring a first rated HARQ buffer size of the code block comprises:
acquiring the total number of all code blocks in a data block corresponding to the code block and a rated storage capacity of a single HARQ process of a single code word; and
dividing the rated storage capacity of the single HARQ process of the single code word by the total number of all code blocks in the data block corresponding to the code block to acquire the first rated HARQ buffer size of the code block.

5. The method according to claim 4, wherein the acquiring a rated storage capacity of a single HARQ process of a single code word comprises:
calculating a rated storage capacity N_{IR} of the single HARQ process of the single code word according to a formula
$${N}_{IR} = ⌊ \frac{{N}_{soft}}{{K}_{C} □ {K}_{MIMO} □ min ( {M}_{DL\_HARQ} , {M}_{limit} )} ⌋ ;$$
wherein N_{soft} is a maximum HARQ buffer size that can be used by the terminal;
K_{C} is a type of the terminal, and a value of K_{C} is 1 or 2 or 5;
K_{MIMO} is used to describe a transmission mode between the terminal and the base station, and a value of K_{MIMO} is 1 or 2;
min is a symbol of calculating a minimum value;
M_{DL}_{_{—}}_{HARQ} is the number of downlink HARQ processes between the base station and the terminal; and
Mₗᵢₘᵢₜ is 8.

6. The method according to claim 5, wherein after the acquiring a rated storage capacity of a single HARQ in a single code word, the method further comprises:
determining the maximum number of carriers that can be used for data transmission between the base station and the terminal;
acquiring the actual number of carriers required for the data transmission between the base station and the terminal;
when it is determined that the actual number of carriers is smaller than the maximum number of carriers, acquiring a rated buffer size of the coded data; and storing soft bits of the coded data sequentially, starting from the first soft bit in the coded data, according to the rated buffer size of the coded data; and
when it is determined that the actual number of carriers is equal to the maximum number of carriers, performing the step of reducing the first rated HARQ buffer size according to the rated proportion to acquire the second rated HARQ buffer size and a subsequent step.

7. The method according to claim 1, wherein after the determining a threshold range in which the second rated HARQ buffer size falls, the method further comprises:
when the second rated HARQ buffer size falls in a second threshold range, acquiring the rated buffer size of the coded data, wherein the second threshold range and the first threshold range do not overlap; and
according to the rated buffer size of the coded data, storing soft bits of the coded data sequentially, starting from the first soft bit in the coded data.

8. The method according to claim 7, wherein a lower limit value of the second threshold range is 3×K_{π}, and an upper limit value is a preset value greater than 3×K_{π}, wherein K_{π} is
$$\frac{1}{3}$$
of the length of the code block.

9. A terminal, comprising:
a receiver configured to receive coded data corresponding to one code block sent by a base station;
a memory storing computer-executable instructions;
a processor configured to execute the computer-executable instructions to cause the terminal to:
decode the coded data, if decoding the coded data fails, acquire a first rated HARQ buffer size of the code block, wherein the first rated HARQ buffer size is a size of space occupied by all soft bits in the coded data;
reduce the first rated HARQ buffer size according to a rated proportion to acquire a second rated HARQ buffer size;
determine a threshold range in which the second rated HARQ buffer size falls; and
store, according to the second rated HARQ buffer size, soft bits in the coded data sequentially, starting from the first soft bit in the coded data, until a size of stored soft bits is equal to the second rated HARQ buffer size when the second rated HARQ buffer size falls in a first threshold range.

10. The terminal according to claim 9, wherein the processor is configured to execute the computer-executable instructions to further cause the terminal to:
acquire the total number of all code blocks in a data block corresponding to the code block and a rated storage capacity of a single HARQ process of a single code word; and
divide the rated storage capacity of the single HARQ process of the single code word by the total number of all code blocks in the data block corresponding to the code block, to obtain a first rated HARQ buffer size of the code block.

11. The terminal according to claim 10, wherein the processor is configured to execute the computer-executable instructions to further cause the terminal to:
calculate the rated storage capacity N_{IR} of the single HARQ process of the single code word according to a formula
$${N}_{IR} = ⌊ \frac{{N}_{soft}}{{K}_{C} □ {K}_{MIMO} □ min ( {M}_{DL\_HARQ} , {M}_{limit} )} ⌋ ;$$
wherein N_{soft} is a maximum HARQ buffer size that can be used by the terminal;
K_{C} is a type of the terminal, and a value of K_{C} is 1 or 2 or 5;
K_{MIMO} is used to describe a transmission mode between the terminal and the base station, and a value of K_{MIMO} is 1 or 2;
min is a symbol of calculating a minimum value;
M_{DL}_{_{—}}_{HARQ} is the number of downlink HARQ processes between the base station and the terminal; and
Mₗᵢₘᵢₜ is 8.

12. The terminal according to claim 11, wherein the processor is configured to execute the computer-executable instructions to further cause the terminal to:
determine the maximum number of carriers that can be used for data transmission between the base station and the terminal;
acquire the actual number of carriers required for the data transmission between the base station and the terminal; and
acquire a rated buffer size of the coded data when the actual number of carriers is smaller than the maximum number of carriers; and
reduce the first rated HARQ buffer size according to the rated proportion to acquire the second rated HARQ buffer size when the actual number of carriers is equal to the maximum number of carriers.

13. The terminal according to claim 9, wherein the processor is configured to execute the computer-executable instructions to further cause the terminal to:
acquire the rated buffer size of the coded data when the second rated HARQ buffer size falls in a second threshold range; and
store soft bits of the coded data sequentially, starting from the first soft bit in the coded data, according to the rated buffer size of the coded data.
